(19) United States
(12) Patent Application Publication
(10) Pub. No.: US 2022/0284011 A1
(43) Pub. Date: Sep. 8, 2022

(54) DISTRIBUTED BLOCKCHAIN TRANSACTION SYSTEM

(71) Applicant: ZEU TECHNOLOGIES, INC., Montreal (CA)

(72) Inventors: Yuming QIAN, Richmond Hill (CA); Francois DUMAS, Montreal (CA); Patricia POPERT-FORTIER, Dorval (CA); Jean-Philippe BEAUDET, Montreal (CA)

(73) Assignee: ZEU TECHNOLOGIES, INC., Montreal, QC (CA)

(21) Appl. No.: 17/632,194

(22) PCT Filed: Aug. 5, 2020
(86) PCT No.: PCT/CA2020/051065

§ 371 Date: Feb. 1, 2022

Related U.S. Application Data
(60) Provisional application No. 62/883,531, filed on Aug. 6, 2019.

(51) Int. Cl. G06F 16/23; H04L 9/00

(52) U.S. Cl. CPC G06F 16/2379; H04L 9/50; G06F 16/2365

(57) ABSTRACT

A system for implementing distributed blockchain transactions that includes: a first participant blockchain comprising a first node; second participant blockchain comprising a second node; and a coordinator blockchain comprising a coordinator node is disclosed. The distributed transaction involves a first transaction on the first participant blockchain, and a second transaction on the N second participant blockchain. The coordinator blockchain is adapted to: transfer secure messages between the coordinator node, and the first and second nodes; and maintain a global status value so as to coordinate the first and second transactions, such that all of the first and second transactions are either committed or rolled back together, thereby leaving the system in a consistent state at the end

### TECHNICAL FIELD

The present application relates generally to a blockchain system, and in particular to a distributed blockchain transaction system employing multiple blockchains.

### BACKGROUND ART

Traditional relational database management systems have been in use for many classes of applications that typically support transactions that should guarantee validity, even in the event of errors. Transactions are individual, indivisible operations that may occur concurrently. A transaction processing system manages concurrent processing of transactions, enables the sharing of data, ensures the integrity of data and manages the prioritization of transaction execution.

Such transactions are thus characterized by a set of properties called atomicity, consistency, isolation, and durability (ACID for short). Atomicity means that all changes to data are performed as if they are a single operation. Consistency requires that data is in a consistent state when a transaction starts and when it ends. Isolation means that the intermediate state of a transaction is invisible to other transactions. Durability implies that after a transaction successfully completes, changes to data persist and are not undone, even in the event of a system failure.

A basic requirement in applications that support transactions, where one operation involves multiple database operations and these records must be all succeed or fail together. For example, a transfer of funds from one bank account to another, even involving multiple changes such as debiting one account and crediting another, is a single database transaction.

Blockchain transactions on the other hand work via consensus. Blockchain technology maintains a reliable record of transactions by means of collective participation and consensus among participants. Blockchain has often been understood and described as a distributed ledger technology (DLT), jointly maintained by multiple networked devices called nodes. Blockchain can thus be thought of as a distributed database system.

Distributed transactions involving blockchains rather than databases involve several challenges. It is an object of the present invention to solve at least some of these challenges to ensure transactions across multiple blockchains either commit or rollback so that the system of multiple blockchains is left in a consistent state satisfying the ACID test.

Some attempts have been made at coordinating operations across different blockchains. A prominent example is the atomic swap. Atomic swaps first garnered attention around September 2017, when Decred and Litecoin conducted the first atomic swap. Since then, some similar services have been enabled by decentralized exchange or protocol such as Shapeshift, 0x, and Altcoin.io.

An atomic swap is a self-executed smart contract which allows for the exchange of different cryptocurrencies without using a trusted third party, such as an exchange or other centralized authority. Atomic swaps utilize a Hash Timelock Contract (HTLC) which requires both parties to verify the completion of the transaction before the expiry of a specified period. If the transaction is not verified in time, it fails and the currencies are returned to their original owners.

However, atomic swaps have problems of their own, including restrictions on accepted cryptocurrencies, hefty transaction fees, and a lack of scalability. Historically these types of transactions were limited to a one-on-one transaction, for example, 0.4 Bitcoin for 10 Ether and do not typically support multiple, i.e., more than two, blockchains. Furthermore, the current swap technology suffers from a lack of scalability as it needs to maintain connectors between ledgers. This creates an exponentially growing number of connectors and associated support assets for each new crypto asset that is integrated into the exchange.

For this reason, such atomic swap technologies and protocols failed to provide a liquid, decentralized, scalable and blockchain agnostic solution.

For transaction atomicity and consistency, transactions on a single blockchain have been solved through their own complex consensus mechanism. For transaction isolation, since the execution of each blockchain smart contract is serialized, this problem does not occur. Durability is satisfied since the blockchain is a permanent, immutable record. However, there are many different types of blockchains. Due to the characteristics of the blockchain itself, cross-chain interoperability is challenging to implement, and each blockchain typically has insufficient resources or interfaces to support such operations.

Accordingly, there is a need for improved systems and methods to mitigate at least some of the aforementioned problems.

### SUMMARY OF INVENTION

Embodiments of the present invention provide a distributed blockchain based transaction system and method that permit transactions across multiple mutually-unrelated blockchain nodes that either all succeed simultaneously or fail simultaneously.

In accordance with one aspect of the present invention there is provided a system for distributed blockchain transactions. The system includes: a first participant blockchain comprising a first node; a second participant blockchain comprising a second node; and a coordinator blockchain comprising a coordinator node; wherein the distributed transaction involves a first transaction on the first participant blockchain, and a second transaction on the second participant blockchain, and wherein the coordinator blockchain is adapted to: transfer secure messages between the coordinator node, and the first and second nodes; and maintain a global status value so as to coordinate the first and second transactions, such that all of the first and second transactions are either committed or rolled back together, thereby leaving said system in a consistent state at the end of said distributed transaction.

In accordance with one aspect of the present invention there is provided a method of executing a distributed blockchain transaction between a first user and a second user, using a system comprising: a first participant blockchain comprising a first contract; a second participant blockchain comprising a second contract; and a coordinator blockchain comprising a third contract, the distributed transaction involving a first transaction on the first chain and a second transaction on the second chain, the method comprising: at the coordinator blockchain: generating a random number seed C and a hash H_{C} computed as H_{C}=hash (Seed C); receiving a hash H₁ computed as H₁=hash (RA+Seed A +H_{C}) from the first participant blockchain wherein Seed A is a random number seed generated at the first chain and RA is a result of a first contract executed on the first chain; receiving a hash H₂ computed as H₂=hash (RB+Seed B +H_{C}) from the second participant blockchain wherein Seed B is a random number seed generated at the second chain and RB is a result of a second contract executed on the second chain; computing a hash H₃=hash (H₁+H₂); executing a commit function of the third contract with Seed C, H₁, H₂ and H₃; collecting and verifying Seed A, Seed B, Seed C and hash values H₁, H₂, H₃; upon verification of Seed A and H₁, committing the first transaction on the first participant blockchain; and upon verification of Seed B and H₂, committing operations of the second participant blockchain.

In accordance with one aspect of the present invention there is provided a method of executing a distributed blockchain transaction between a first user and a second user, using a system comprising: a first participant blockchain comprising a first contract; a second participant blockchain comprising a second contract; and a coordinator blockchain comprising a third contract, the distributed transaction involving a first transaction on the first chain and a second transaction on the second chain, the method comprising: at the first participant blockchain: a) receiving a random number seed C and a hash H_{C} computed as H_{C} =hash (Seed C) from the coordinator blockchain; b) generating hash H₁ computed as H₁=hash (R_{A}+Seed A+H_{C}) wherein Seed A is a random number seed generated at the first chain and RA is a result of a first contract executed on the first chain; c) checking H₁ with Seed C; and upon successful checking, releasing Seed A.

In accordance with one aspect of the present invention there is provided a method of executing a distributed blockchain transaction between a first user and a second user, using a system comprising: a first participant blockchain comprising a first contract; a second participant blockchain comprising a second contract; and a coordinator blockchain comprising a third contract, the distributed transaction involving a first transaction on the first chain and a second transaction on the second chain, the method comprising: at the first participant blockchain: receiving a random number seed C and a hash H_{C} computed as H_{C}=hash (Seed C) from the coordinator blockchain; generating hash H₂ computed as H₂=hash (R_{B}+Seed B+H_{C}) wherein Seed B is a random number seed generated at the second participant blockchain and R_{B} is a result of the second contract executed on the second participant blockchain; checking H₂ with Seed C; and upon successful checking, releasing Seed B.

In addition, transaction fraud detection mechanisms are disclosed.

### BRIEF DESCRIPTION OF DRAWINGS

In the figures, which illustrate by way of example only, embodiments of the present invention,

FIG. 1 is a simplified schematic diagram of a system, exemplary of an embodiment of the present invention, implementing a distributed transaction across multiple blockchains;

FIG. 2 is simplified a schematic activity diagram of a multi-phase coordinated transaction across multiple nodes;

FIG. 3 is an exemplary system deployment architecture in accordance with an exemplary embodiment of the present invention;

FIG. 4 a diagram of an exemplary execution flow of blockchain cross-chain transactions;

FIG. 5 is a diagram of an exemplary failure process of a contract Preparation Phase consensus;

FIG. 6 is a flowchart diagram depicting an exemplary method for detecting and avoiding Participant or coordinator fraud; and

FIG. 7 is a flowchart summarizing the steps for handles a transaction timing out.

### DESCRIPTION OF EMBODIMENTS

At least some embodiments of the present invention address issues related to transaction management in distributed blockchain environments that involve multiple blockchains rather than traditional database management systems.

A description of various embodiments of the present invention is provided below. In this disclosure, the use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like. Directional terms such as “top”, “bottom”, “upwards”, “downwards”, “vertically” and “laterally” are used for the purpose of providing relative reference only, and are not intended to suggest any limitations on how any article is to be positioned during use, or to be mounted in an assembly or relative to an environment.

The terms “comprising”, “having”, “including”, and “containing”, and grammatical variations thereof, are inclusive or open-ended and do not exclude additional, un-recited elements and/or method steps. The term “consisting essentially of ” when used herein in connection with a composition, use or method, denotes that additional elements, method steps or both additional elements and method steps may be present, but that these additions do not materially affect the manner in which the recited composition, method, or use functions. The term “consisting of ” when used herein in connection with a composition, use, or method, excludes the presence of additional elements and/or method steps.

In addition, the terms “first”, “second”, “third” and the like are used for descriptive purposes only and cannot be interpreted as indicating or implying relative importance.

In the description of the invention, it should also be noted that the terms “mounted”, “linked” and “connected” should be interpreted in a broad sense unless explicitly defined and limited otherwise. For example, it could be fixed connection, or assembled connection, or integrally connected; either hard-wired or soft-wired; it may be directly connected or indirectly connected through an intermediary. For those of skill in the art, the specific meanings of the above terms in the invention may be understood in context.

In the present disclosure, the terms “blockchain” and “chain” may be used interchangeably.

In the drawings illustrating embodiments of the present invention, the same or similar reference labels correspond to the same or similar parts. In the description of the invention, it should be noted that the meaning of “a plurality of” means two or more unless otherwise specified. The directions or positions of the terms “up”, “down”, “left”, “right”, “inside”, “outside”, “front end”, “back end”, “head”, “tail”, the orientation or positional relationship shown in the drawings is merely for the convenience of describing the invention and simplifying the description rather than indicating or implying that the indicated device or element must have a particular orientation and be constructed and operated in a particular orientation, and therefore cannot be used as a limitation of the invention.

A transaction provides a mechanism to incorporate all operations involved in an activity into an indivisible execution unit. All operations that make up a transaction can be committed only if all operations are performed successfully; if any of the operations fail, this causes a rollback of the entire transaction. Simply put, transactions provide an “all or nothing” mechanism.

As noted above in the background, traditional transactions are characterized by a set of properties called atomicity, consistency, isolation, and durability (ACID).

Atomicity means that all changes to data are performed as if they are a single operation.

Consistency requires that data is in a consistent state when a transaction starts and when it ends. If the transaction is completed successfully, all changes in the system are applied correctly and the system is in a valid state. If an error occurs in a transaction, all changes in the system are automatically rolled back, and the system returns to the original state.

Isolation means that the intermediate state of a transaction is invisible to other transactions. In a concurrent environment, each transaction has its own complete data space when different transactions manipulate the same data at the same time.

Durability implies that after a transaction successfully completes, changes to data persist and are not undone, even in the event of a system failure.

In a distributed blockchain environment, operations in each chain may be considered as a transaction in the sense that the operations conform to the aforementioned ACID test.

At present, existing cross-chain transaction schemes only support a single type of operation such as token transfer, with the majority of them only supporting interaction between two chains. More complicated transactions, including those involving more than two chains, are not known to be supported.

In one exemplary embodiment, a solution is provided to the problem of distributed transaction transactions across multiple heterogeneous blockchain systems, where unlike the traditional distributed trading environments, no node is trusted.

The solution provided by the embodiment involves solving the problems of: providing trusted transmission mechanism for distributed transaction messages; ensuring that distributed trading node operation is trusted; ensuring distributed transaction data consistency; and ensuring atomicity of the distributed transaction result.

### System Architecture

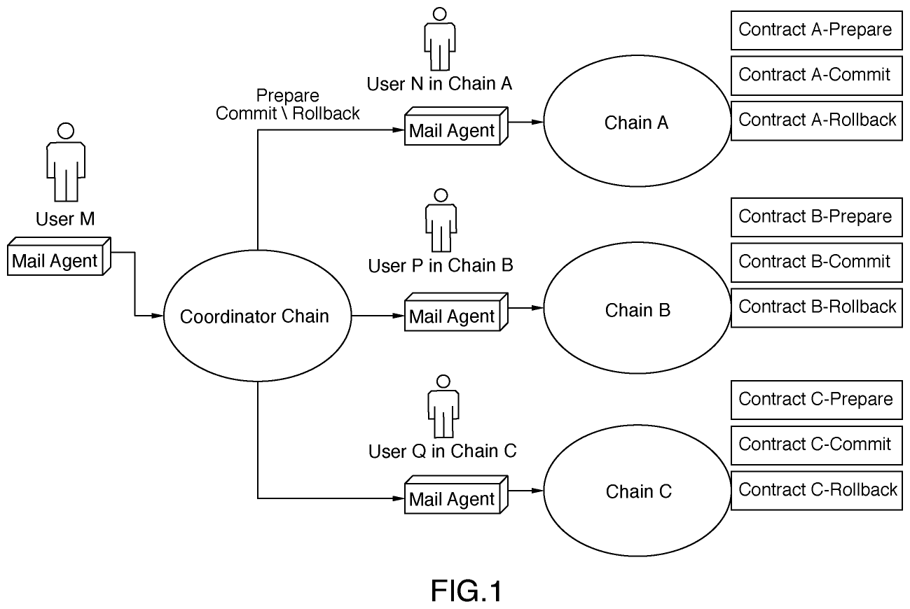

A schematic block diagram of the architecture for an exemplary system is shown in FIG. 1. The system includes blockchains A , B and C. For distributed transaction operations to be performed across the independent blockchains, the distributed transaction activates smart contracts on each chain, and the smart contract operations on each chain must succeed or fail simultaneously.

One exemplary solution is to first transform the smart contract on each chain, and divide the original one-time operation into three phases.

In the first phase, called “Preparation Phase”, all the resources involved in the smart contract are locked to ensure that other smart contracts or users cannot use the resource before the smart contract is fully executed. For example, if tokens are involved, the user token is transferred from the user account to the third-party security account (such as the interim coordinator account), and the resources in other blockchains can complete the resource lock by using a tag to indicate that the resource as locked.

In the second phase, called “Commit Phase”, each of the parties have successfully completed their respective Preparation Phase. First, each node submits a contract completion certificate to the coordinator blockchain 101, and the coordinator verifies the proof on each chain to confirm that each chain has completed the Preparation Phase after which, it can enter the Commit Phase. The Commit Phase releases the locked resources and completes the corresponding token or data operation according to the logic requirements of the smart contract. Since the contract-related resources have been transferred to the interim coordinator account in the Preparation Phase, the contract is required to initiate operations with proof that the Preparation Phase stages on all nodes had finished successfully. At the same time, the proof needs to be verified during the execution of the contract.

In the third phase, called “Rollback Phase”, if any of the participants in the Preparation Phase fails to perform the contract Preparation Phase operation, or if any node provides a false certificate, then the global transaction cannot be performed. The relevant chain executes the rollback contract, which releases locked resources, and the value of any affected data reverts back to the previous state that existed before the execution of the Preparation Phase contract.

To ensure that the contract does not stop in an interim state, there is a timeout mechanism. When the Commit Phase or Rollback Phase is not triggered, each chain user could perform an operation (i.e., commit or rollback) according to records in the coordinator blockchain 101.

### Transaction Coordination

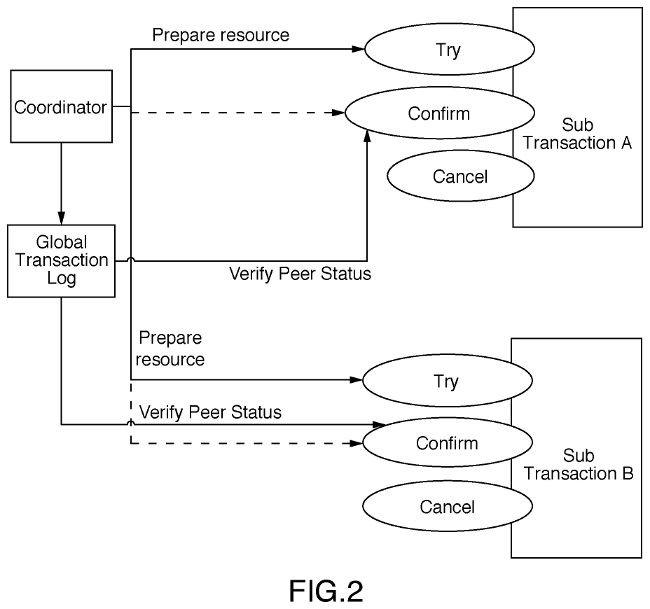

FIG. 2 depicts a schematic activity diagram of a multi-phase coordinated transaction across multiple nodes. When a transaction has multiple participants, a third-party transaction coordinator is introduced to coordinate the execution of distributed transactions across multiple nodes. The main idea is to register a corresponding acknowledgment and/or compensating action or undo action for each operation. The activity may be divided into three phases:

The first phase, called “Try Phase” is used to detect consistency and reserve resources (quasi-isolation) for business systems.

The second phase, called “Confirm Phase” is used to confirm the submission of the business system. When the Try Phase is successfully executed, and the Confirm Phase is started, the default Confirm Phase will not go awry. In this embodiment, as long as the Try Phrase succeeds, the Confirm Phase must also succeed. The Confirm Phase operation satisfies idempotency. If the Confirm Phase fails, a retry is required.

The third phase, called “Cancel Phase” is used to cancel the service performed in a state where the business execution error is detected, and resource release is reserved. The Cancel Phase operation also satisfies idempotency.

In one embodiment, to ensure that the system remains in a consistent state after a phase or node crash, the distributed transaction model records the current state in each node. The coordinator blockchain interacts with all sub-chains and records the global transaction status on the coordinator blockchain. The global transaction state and the state of the transaction on each sub-chain must be consistent. Each sub-chain records the state of the local transaction execution and the global transaction hash code. In this embodiment, sub-chains do not communicate with each other but only with the coordinator.

To ensure that cross-chain communication is secure and reliable, cross-chain messages are passed through the coordinator blockchain. All messages are encrypted by the sender of the message using the recipient's public key, i.e., wallet address. After receiving the message, the recipient decrypts the message using their private key in its wallet. Therefore, it can be confirmed in this way that the recipient and the content of each message are encrypted and securely transferred. The public key of the wallet can be verified on-chain, while the private key is kept secret and cannot be obtained by anyone else.

### System Deployment Architecture

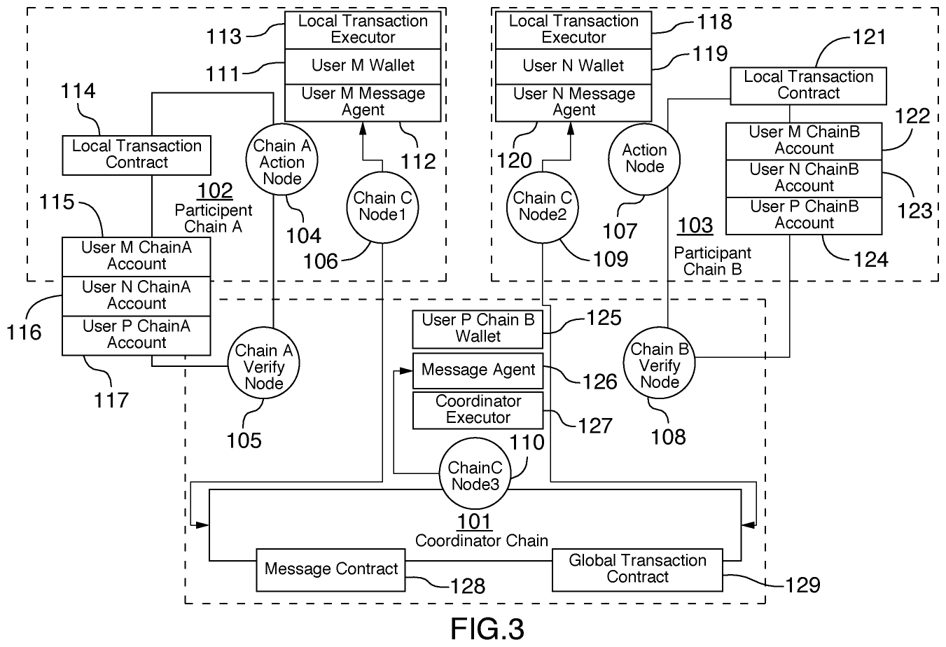

FIG. 3 is a schematic diagram of a system, exemplary of an embodiment of the present disclosure, illustrating an exemplary deployment architecture. The system includes of a coordinator blockchain 101 and two participant blockchains 102, 103.

The system includes a local transaction executor 113, a wallet for user M 111, a message agent for user M 112 in blockchain 102.

The system also includes a local transaction executor 118, a wallet for user N 119, a message agent for user N 120 in blockchain 103.

The system further includes a local transaction contract 114, and accounts 115, 116, 117 for users M, N and P respectively.

The system further includes a local transaction contract 121, and accounts 122, 123, 124 for users M, N and P respectively.

The system includes a coordinator executor 127, a wallet for user P 125, and a message agent 126.

The system also includes nodes 104, 105, 106, 107, 108, 109 and 110 as will be described below.

Coordinator blockchain 101 is used to transfer security messages between participants and coordinators. It also records the status of global transactions. On the coordinator blockchain 101, there are deployed secure message contracts 128 and global transaction coordination contracts 129. Blockchain 102 is used to execute local contract 114. blockchain 103 is used to execute local contract 121.

Node 104 may have a local transaction contract triggered by User M, and User M can directly access Blockchain A or blockchain 102 through node 104. For example, if it is desired to transfer 10 Ether from User M to User N, User M must be authorized to invoke the contract as the private wallet is only accessed by User M. This node retains the data of blockchain 102 and the wallet of User M. No other users, except User M, should have access to node 104. After the Preparation Phase is completed, User M needs to send contract status proof, i.e., hash values, to the coordinator blockchain 101.

Node 105 is a verification node for blockchain 102, is deployed in the coordinator area and is operated by the coordinator to verify whether the local Preparation Phase transaction has been completed on the Chain A or blockchain 102 and to extract the corresponding evidence. During the Commit Phase, the coordinator triggers a Commit or Rollback operation of blockchain 102 or blockchain A′s local contract through this node 105. User P acts as the coordinator user to synchronize the status and data of Blockchain A through the node, verifying Blockchain A′s local transaction completion status and triggering the contract operation on Blockchain A.

Node 106 belongs to the coordinator blockchain 101, but is deployed in the domain of User N. User N can synchronize the data and status of the coordinator blockchain through this node and check the evidence of the completion of local transactions of other nodes.

Node 107: Chain 103′s contract triggers node 107, which is deployed in the domain of User M. User M has the access right of the node, and the node can trigger the local contract.

Node 108: Chain 103 verifies node 108, which belongs to blockchain 103 but is deployed in the coordinator area and is operated by the coordinator to verify whether the local Preparation Phase transaction has been completed on Chain A or blockchain 102 and extract corresponding evidence. During the Commit Phase, the coordinator triggers a Commit or Rollback operation of the Blockchain A′s local contract through the node 108. User P acts as the coordinator user to synchronize the status and data of blockchain A through the node, verifying Blockchain A′s local transaction completion status and triggering the contract operation on Blockchain A.

Node 109: coordinator blockchain 101 verifies the node 109, which belongs to the coordinator blockchain 101, but is deployed in the domain of User M. User M can synchronize the data and status of the coordinator blockchain 101 through this node and check the evidence of the completion of local transactions of other nodes.

Node 110: Coordinator blockchain 101′s execution node belongs to the coordinator blockchain 101 and is deployed in the domain of the coordinator. User P acts as a coordinator to trigger the coordinator Contract through the node and then writes the global transaction status and its evidence into the coordinator blockchain 101 for nodes 106, 109 to query.

User M′s wallet 111 is used to save User M′s private key, and is used to implement encrypted message transmission.

User M′s messaging agent 112 listens to encrypted messages sent to User M in the coordinator blockchain 101 at any time. When the messaging agent 112 receives the encrypted message from the coordinator blockchain 101, it encrypts the private key pair in the wallet. The message is decrypted, restored to the instruction, and handed over to local transaction executor 113 for execution.

User M′s local executor 113 is configured to execute the received action's instructions; activate the smart contract on the blockchain A or check the global contract status on the coordinator blockchain 101; or synchronize the local execution result certificate to the coordinator blockchain 101 through node 106.

Blockchain A′s local transaction contract 114 is divided into three parts, Preparation, Commit, and Rollback, which are called respectively according to the global contract status. The Preparation Phase is called by User M. Commit or Rollback is called by User P, acting as the coordinator. If it times out, Rollback is called by each participant user.

There are several accounts including User M Blockchain A′s account 115, User N Blockchain A′s account 116 and User P Blockchain A′s account 117.

User N′s command executor 118 is configured to execute the received action's instructions; activate the smart contract on Blockchain B or check the global contract status on the coordinator blockchain 101; or synchronize the local execution result certificate to the coordinator blockchain 101 through the 109 node.

User N′s wallet 119 stores the private key of the User N. When User N receives the encrypted message, the private key is decrypted.

User N′s messaging agent 120 listens to the information sent to the User N by the chain 101, and calls the private key of the User N to decrypt the information. When a feedback message needs to be sent to the coordinator, the module obtains the coordinator's public key to encrypt the data and send it to the message contract on the coordinator blockchain.

Blockchain B′s local transaction contract 121 is divided into three parts, Preparation, Commit, and Rollback, which are respectively called according to the global contract state. The Preparation part is called by User N. Commit or Rollback is called by User P, acting as coordinator. If it times out, it automatically calls Rollback.

There are several further accounts including User M Blockchain B′s account 122, User N Blockchain B′s account 123 and User P Blockchain B′s account 124. User P′s wallet 125 stores the private key of User P.

Using message agent 126, User P′s message proxy listens to the message sent to User P on the coordinator blockchain and performs encryption and decryption processing.

User P, acting as coordinator executor 127, activates the transaction coordination contract on the coordinator blockchain, and performs Commit or Rollback actions of each node transaction on each sub-chain. The coordinator also needs to obtain and verify the contract execution evidence of each node.

### Blockchain Cross-Chain Transactions

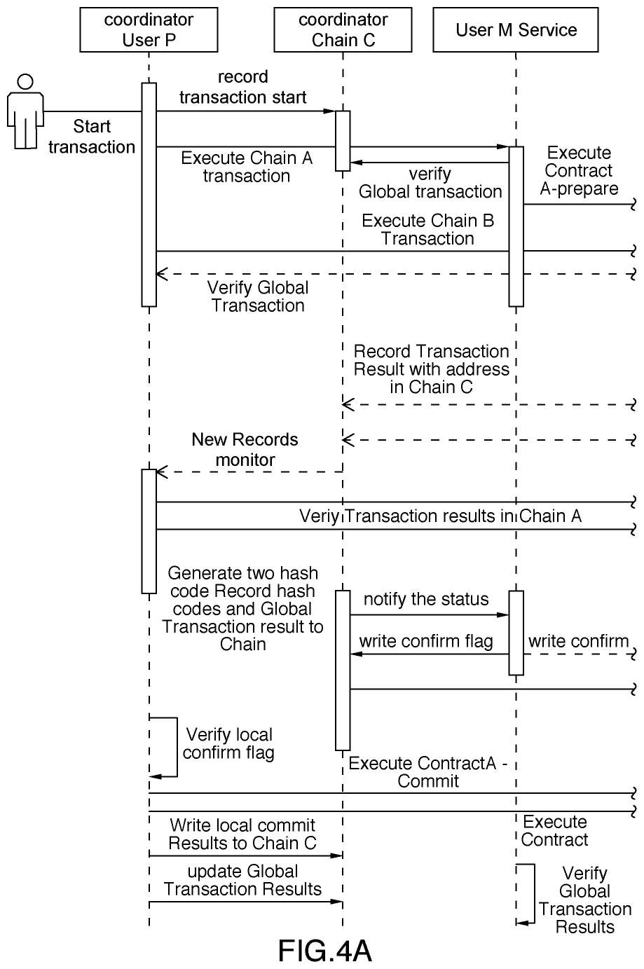

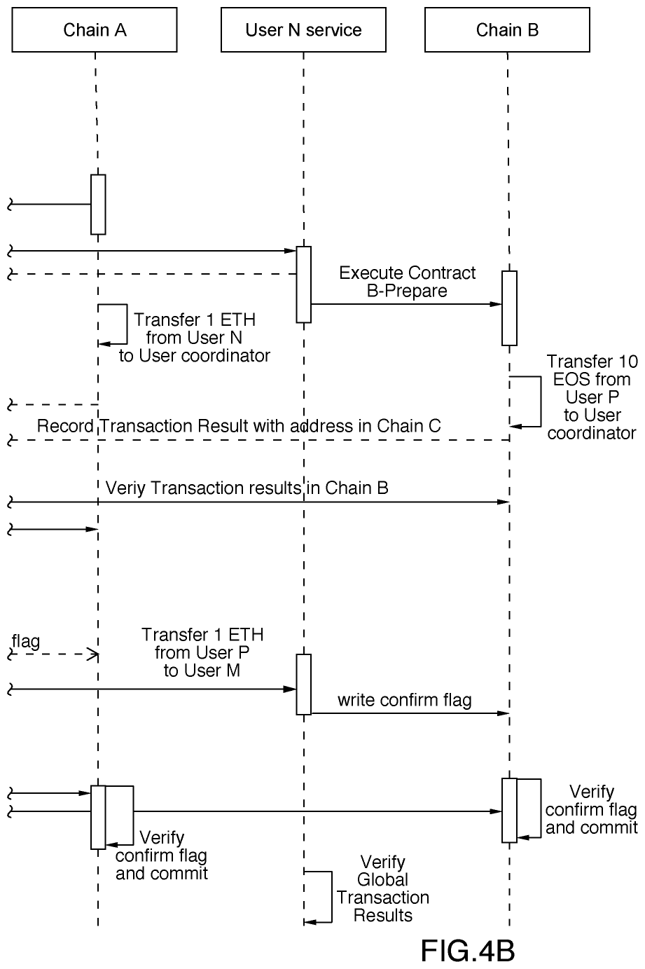

FIG. 4 depicts an exemplary execution flow of blockchain cross-chain transactions. An example is used to illustrate the execution flow of blockchain cross-chain transactions. Suppose User M has 1 Ether on first blockchain A (e.g., the ETHEREUM™ chain) and User N has 10 EOS on a second blockchain B (i.e., the EOS™ chain). The users want to exchange 1 Ether for 10 EOS. This cross-chain transaction needs to perform the following two transactions on the Ethereum and EOS chains respectively: On the first Ethereum, blockchain, User M transfers 1 Ether to User N. On the EOS chain, User N transfers 10 EOS to User M.

As noted above, FIG. 4 depicts an execution flow of blockchain cross-chain transactions which involve several steps or stages.

In STEP 1: User P initiates the distributed transaction. This may also be a user sending a message to User P to initiate a distributed transaction.

In STEP 2: User P generates a random number seed and calculates the seed hash value. User P records the start of the distributed transaction on the coordinator blockchain 101 and records the seed and hash value.

In STEP 3: User P sends a security message to User M and User N, respectively. The message informs User M that User N is executing the Preparation Phase function in Contract A and the Preparation Phase function in Contract B on the Ethernet and EOS chains, respectively. The Contract parameter is the hash value of User P′s seed and the related transaction parameters.

In STEP 4: User M receives this information. User M verifies that the global transaction has been started in the coordinator blockchain and that the parameters are correct.

In STEP 5: User M performs the transfer transaction in the Ethernet Preparation Phase, transfers 1 Ether in User M′s wallet to the User P, acting as the coordinator, generates a random number, calculates the hash value of the random number, and uses the hash value as a parameter. This information is passed to the Ethernet contract parameters. The hash value is recorded on the Ethernet chain in the contract.

In STEP 6: User M, upon successful execution of the contract, starts a distributed trading contract on the coordinator blockchain and record the local Preparation Phase transaction result in the coordinator blockchain. The coordinator blockchain displays the random number generated by User M.

In STEP 7: User N executes the contract Preparation Phase on the blockchain EOS, transfers 10 EOS from User N to the User P, acting as the coordinator, and records the contract execution state on the EOS chain. The generated random number hash value is also stored in the EOS chain. The local Preparation Phase contract execution and result are combined with the original random number to generate a new HASH value H₁=HASH (Preparation Phase result+original random number) to be handed over to the coordinator blockchain 101 contract.

In STEP 8: The coordinator blockchain 101 contract writes the results of the Preparation Phase of the coordinator blockchain 101 contract after obtaining the results of all participating nodes and the original random number.

In STEP 9: The coordinator blockchain 101 writes the global execution result and the Hi hash value reported by all nodes to each participating chain contract. After the contract judgment on each participating chain is consistent with the local random number, the local random number is revealed to the coordinator.

In STEP 10: User P, acting as the coordinator, obtains the random number generated by participating Users M and N through the contract in each participant blockchain, and passes it to the Commit function of the contract on the Ethernet chain and executes it. After the Commit function obtains the random number, it verifies the random number of each node and the Preparation Phase. If the contract status is consistent with the previously saved H₁ hash values for each node, it executes the action of transferring 1 Ether from User P to User N. After completing the Commit Phase task, User P, acting as the coordinator, modifies the global transaction status on the coordinator blockchain 101.

In STEP 11: User P, acting as the coordinator, obtains the random number generated by participating Users M and N through the contract in each participant blockchain, and passes it to the Commit function of the contract on the Ethernet chain and executes it. After the Commit function obtains the random number, it verifies the random number of each node and the Preparation Phase. If the contract state is consistent with the previously saved Hi hash values for each node it executes the action of transferring 1 Ether from User P to User N. After completing the Commit Phase task, User P, acting as the coordinator, modifies the global transaction status on the coordinator blockchain 101.

In STEP 12: The third party can call the contract's “verify” operation through User M, N, and P and verify that the specified executor activated the global task at each stage and confirm that the contract execution is correct.

In STEP 13: After obtaining the random number of all participating nodes, the coordinator contract recalculates H=HASH(M+N+HASH(P)) and confirms that it is consistent with the coordinator blockchain 101 Commit Phase value. This sets the global distributed transaction operation status to complete and signals the end of the distributed cross-chain transaction.

In STEP 14: If any node does not successfully perform the Commit Phase operation, the contract does not record H=HASH(M+N+HASH(P)). After the coordinator Node collects all the Commit Phase feedback, verification on the corresponding chain fails as the global transaction could not be submitted. In this case, because the Preparation Phase action has been executed successfully, the coordinator Node tries to re-run the Commit Phase transaction until it succeeds.

In STEP 15: If any node fails before the Preparation Phase, the normal coordinator Node actively executes the Rollback Phase contract operation and return the successfully executed Preparation Phase action to the pre-execution state in the corresponding chain. In this example, the Rollback Phase operation on the Ethernet chain means that User P, acting as the coordinator, transfers 1 Ether back to User M. The Rollback Phase operation on the EOS chain means that User P, acting as the coordinator, transfers 10 EOS back to User N.

In STEP 16: If all the Preparation Phase transactions are successful, yet a node wants to terminate the contract, the system automatically enforces the Commit Phase contract function.

In STEP 17: If the Commit Phase or Rollback Phase of a node transaction is not activated before the timeout period expires, the distributed transaction timeout fails. The coordinator automatically executes the Rollback Phase contract function or automatically executes the Commit Phase contract operation according to the global Preparation Phase execution result.

In STEP 18: If the content of the message sent by any node to the other nodes does not match the result of the local contract execution, the other nodes can quickly find and stop the related contract from being executed by verifying the original value and the hash value.

### Failure Process of Contract Preparation Phase

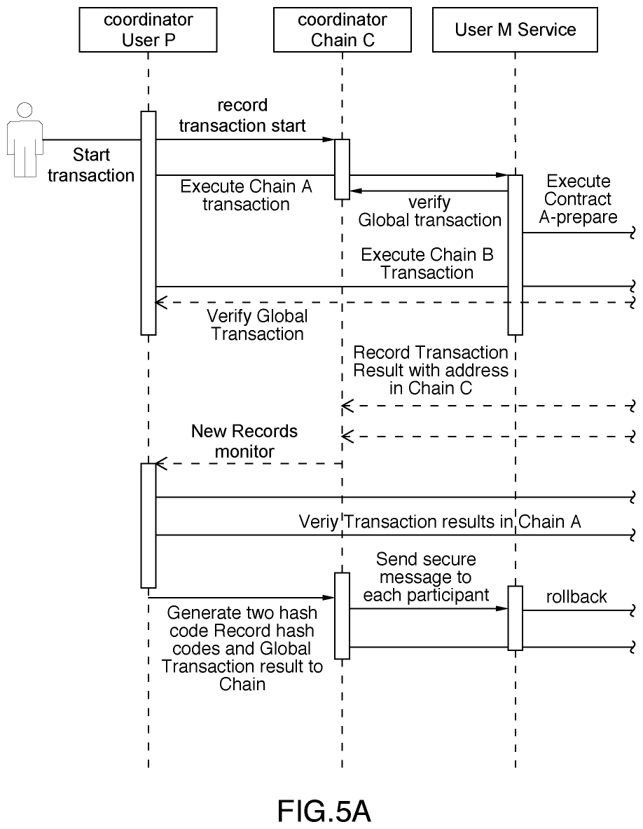

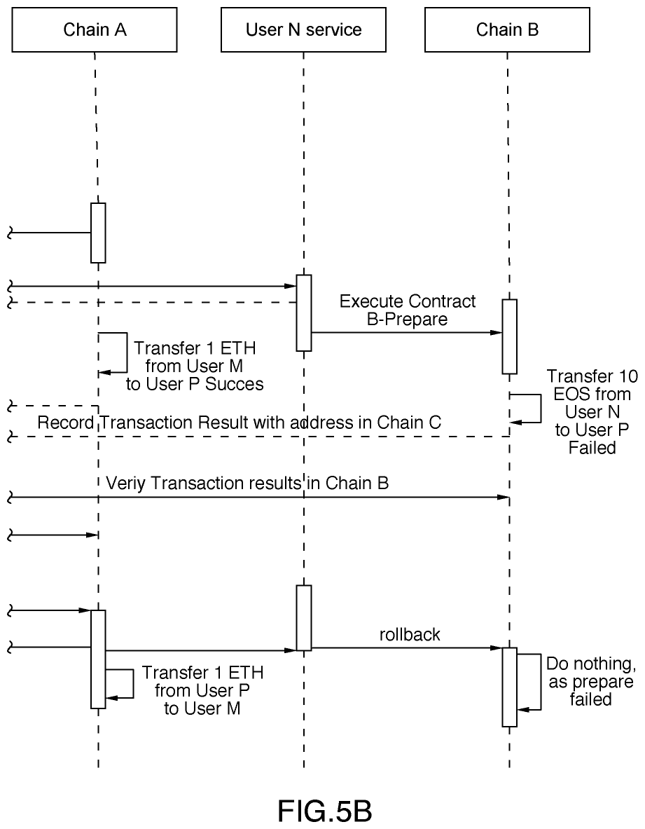

FIG. 5 depicts a failure process of the contract Preparation Phase consensus.

STEPS 1-7: These are the same as the successful execution process. The difference is that the transaction on one chain may fail. Here it is assumed that the contract from User N of 10 EOS to User P, acting as the coordinator, on the EOS chain has failed.

STEP 8: User P, acting as the coordinator, is notified by each node of the local Preparation Phase contract execution result through a security message.

STEP 9: User P, acting as the coordinator, verifies the contract execution result of each chain and writes the result to coordinator blockchain 101.

STEP 10: Because not all the steps of the Preparation Phase operations are successful, User P, acting as the coordinator, activates the contract on each chain, performs the Rollback Phase operation, and provides the original value of the random number of each node as the contract input.

STEP 11: If the HASH value recorded in the contract inspection contract of each participating chain is consistent with the original random number passed in the coordinator, then the contract starts running.

STEP 12: Each contract executes the Rollback Phase operation. blockchain 102 transfers 1 Ether from User P, acting as the coordinator, to User M. blockchain 103 has failed to perform the Rollback Phase operation because the contract operation of the contract transaction has failed.

STEP 13: User P, acting as the coordinator, writes the Rollback Phase execution result to the coordinator blockchain 101. If any sub-chain Rollback Phase operation fails, each sub-chain periodically retries until it succeeds. For example, one possible scenario is that the contract is executed halfway. All the participants have transferred the assets to the User P, acting as the coordinator, but User P has misappropriated the asset, resulting in insufficient assets in the Rollback Phase. Unable to complete the Rollback Phase action, it is retried regularly; as long as at some point, there are sufficient funds in the User P′s account, the Rollback Phase action is completed.

STEP 14: Any participant can match the random number HASH value recorded in the contract process through the original random number provided by the parties to verify the correctness of the contract status.

### Method to Avoid Participant or Coordinator Fraud

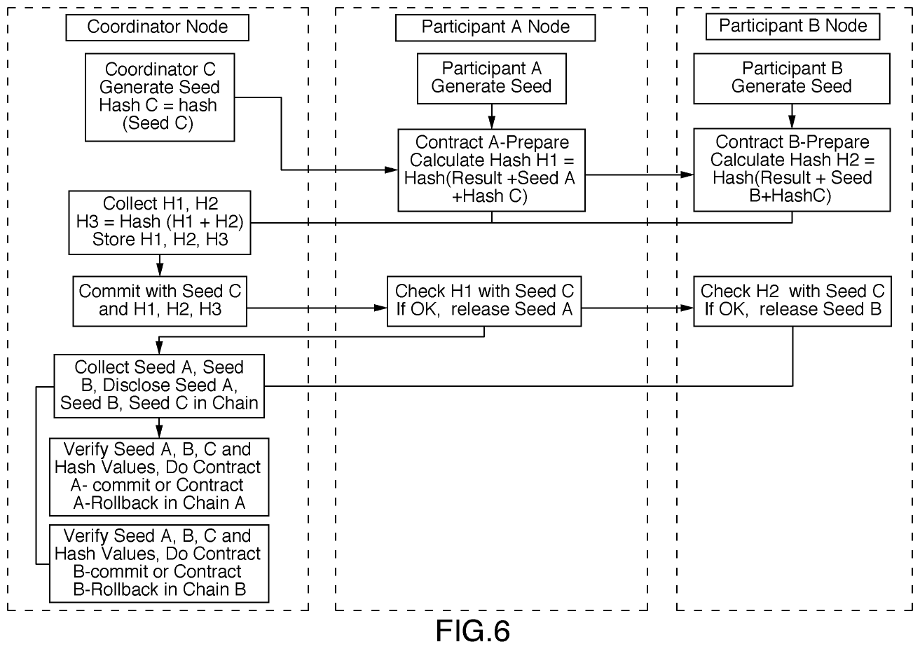

A block diagram representing a method to avoid fraud by either a participant or the coordinator is shown in FIG. 6.

Assuming the User M is a fraud, in the local Preparation Phase contract, the contract should be called to transfer 1 Ether to User P, acting as the coordinator, but is not called. At this time, User M sends a successful Commit Phase operation to User P, acting as the coordinator, and sends a HASH H₁=(Result+Seed A+Hash C).

User P, acting as the coordinator, uses this hash value to verify the contract execution result on Blockchain A. Since the Preparation Phase operation has not been executed, the correct result is not saved in the chain, so the H₁ value must be wrong and, therefore, it is impossible for it to pass verification. User P, acting as the coordinator, can discover that the User M is fraudulent in time.

Assuming that User P, acting as the coordinator, is a fraud, even if all the node user Preparation Phase contracts have been executed successfully when the next stage is executed, the false notification blockchain 102 says that the blockchain 103 contract failed to execute and needs to perform the Rollback Phase.

At this time, User M compares the original value of the random number of the User P, acting as the coordinator, to the contract with the value of the previous state of the Preparation Phase H₁ written by the Preparation Phase. Since User P, acting as the coordinator, falsifies the result, the H₁ calculation value may not be consistent; therefore, User M can know User P, acting as the coordinator, is tampering with the results in time; thus rejecting the Rollback Phase.

In this case, due to the contract coordinator's cheating, the global transaction cannot be coordinated correctly, and the global transaction of all nodes enters a suspended state until a new trusted coordinator provides the correct execution result of the other Coordinators to each participant blockchain. Each participant contract determines whether the Rollback Phase or Commit Phase is based on the global execution result.

### Transaction Time Out

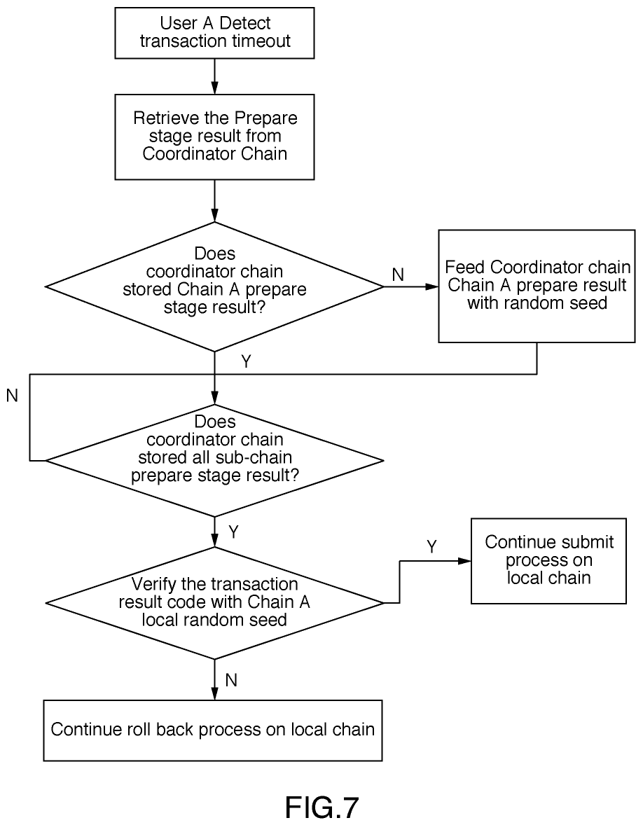

The method for how the system handles a transaction timing out is summarized in the flowchart depicted in FIG. 7.

If, for some reason, a global transaction does not reach its final state before timing out, the user of each node can actively query the current global transaction execution state on the coordinator blockchain 101, and feed the local contract with results from coordinator transactions. The local contract decides whether the local blockchain transaction should commit or rollback the operation in accordance with the global transaction state.

To prevent the user in each sub-chain from submitting a false claim, the user is required to get the correct Preparation Phase stage result, hash code, and random seed for each chain before he or she can trigger Commit Phase or Rollback Phase in the local contract.

The premise of the blockchain contract to commit or rollback a transaction in this chain depends on whether the user provides the correct random number of all nodes. When the coordinator contract correctly obtains all the random numbers of each sub-chain, the user of each sub-chain can extract the random number from the coordinator blockchain 101 hash. The value and the execution result status from each sub-chain are forwarded to the local sub-chain for verification. After the verification is passed, the local sub-chain contract is determined to be Commit Phase or Rollback Phase according to whether the global Preparation Phase succeeds. If there is no complete certificate of all node random numbers on the coordinator blockchain 101 after the timeout, all sub-chain contracts are suspended until all the valid random seeds in each chain are provided. In this way, any user can be prevented from submitting fraudulent data.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. A system for a distributed blockchain transaction, the system comprising:
a) a first participant blockchain comprising a first node;
b) a second participant blockchain comprising a second node; and
c) a coordinator blockchain comprising a coordinator node;
wherein the distributed transaction involves a first transaction on the first participant blockchain, and a second transaction on the second participant blockchain, and
wherein the coordinator blockchain is adapted to: transfer secure messages between the coordinator node, and the first and second nodes; and maintain a global status value so as to coordinate the first and second transactions, such that all of the first and second transactions are either committed or rolled back together, thereby leaving said system in a consistent state at the end of said distributed transaction.

2. The system of claim 1, further comprising a third participant blockchain having a third node, the distributed transaction further involving a third transaction on the third participant blockchain, wherein all of the first, second and third transactions are either committed or rolled back together.

3. The system of claim 1, wherein the secure messages are encrypted by the coordinator blockchain.

4. The system of claim 1, further comprising a first messaging agent at the first participant blockchain listening for a subset of said messages sent to a first user.

5. The system of claim 1, further comprising a second messaging agent at the second participant blockchain listening for a subset of said messages sent to a second user.

6. The system of claim 1, wherein the distributed transaction comprises:
a) a first “try” phase, used to detect consistency of each blockchain and reserve resources;
b) a second “confirm” phase used to confirm submission of the distributed transaction to the system; and
c) a third “cancel” phase used to cancel the service performed in case of error, and release the resources.

7. The system of claim 5, wherein upon a successful execution of the first try phase, the second confirm phase is started, and wherein the second confirm phase must also succeed.

8. The system of claim 5, wherein the second confirm phase satisfies idempotency.

9. The system of claim 5, wherein the third cancel phase operation satisfies idempotency.

10. The system of claim 1, wherein the first participant blockchain is ETHEREUM™ and the second participant blockchain is EOS™.

11. A method of executing a distributed blockchain transaction between a first user and a second user, using a system comprising: a first participant blockchain comprising a first contract; a second participant blockchain comprising a second contract; and a coordinator blockchain comprising a third contract, the distributed transaction involving a first transaction on the first chain and a second transaction on the second chain, the method comprising:
at the coordinator blockchain:
a) generating a random number seed C and a hash H_{C} computed as H_{C}=hash (Seed C);
b) receiving a hash H₁ computed as H₁=hash (R_{A}+Seed A+H_{C}) from the first participant blockchain wherein Seed A is a random number seed generated at the first chain and R_{A} is a result of a first contract executed on the first chain;
c) receiving a hash H₂ computed as H₂=hash (R_{B}+Seed B+H_{C}) from the second participant blockchain wherein Seed B is a random number seed generated at the second chain and R_{B} is a result of a second contract executed on the second chain;
d) computing a hash H₃=hash (H₁+H₂);
e) executing a commit function of the third contract with Seed C, H₁, H₂ and H₃;
f) collecting and verifying Seed A, Seed B, Seed C and hash values H₁, H₂, H₃;
g) upon verification of Seed A and H₁, committing the first transaction on the first participant blockchain; and
h) upon verification of Seed B and H₂, committing operations of the second participant blockchain.

12. The method of claim 9, further comprising: a subset of said messages that are from the first participant blockchain to the second participant blockchain, are passed through the coordinator blockchain.

13. The method of claim 9, further comprising: a subset of said messages that are from the second participant blockchain to the first participant blockchain, are passed through the coordinator blockchain.

14. The method of claim 9, wherein:
sending a security message to the first user and the second user respectively, the security message informing the first user that the second user is executing a first Preparation Phase function in the first contract and a second Preparation Phase function in the second contract.

15. The method of claim 9, further comprising: after completing the third commit phase, modifying the global transaction status on the coordinator blockchain.

16. The method of claim 9, further comprising:
a) detecting a time out of the distributed transaction by the first user; and
b) retrieving prepare phase results from the coordinator blockchain;
c) upon verification of R_{A} with Seed A, committing the first transaction on the first chain; and rolling back the distributed transaction otherwise.

17. The method of claim 9, further comprising:
a) detecting a time out of the distributed transaction by the second user; and
b) retrieving prepare phase results from the coordinator blockchain;
c) upon verification of R_{B} with Seed B, committing the second transaction on the second chain; and rolling back the distributed transaction otherwise.

18. A method of executing a distributed blockchain transaction between a first user and a second user, using a system comprising: a first participant blockchain comprising a first contract; a second participant blockchain comprising a second contract; and a coordinator blockchain comprising a third contract, the distributed transaction involving a first transaction on the first chain and a second transaction on the second chain, the method comprising:
at the first participant blockchain:
a) receiving a random number seed C and a hash H_{C} computed as H_{C} =hash (Seed C) from the coordinator blockchain;
b) generating hash H₁ computed as H₁=hash (R_{A}+Seed A+H_{C}) wherein Seed A is a random number seed generated at the first chain and RA is a result of a first contract executed on the first chain;
c) checking H₁ with Seed C; and upon successful checking, releasing Seed A.

19. A method of executing a distributed blockchain transaction between a first user and a second user, using a system comprising: a first participant blockchain comprising a first contract; a second participant blockchain comprising a second contract; and a coordinator blockchain comprising a third contract, the distributed transaction involving a first transaction on the first chain and a second transaction on the second chain, the method comprising:
at the first participant blockchain:
a) receiving a random number seed C and a hash H_{C} computed as H_{C}=hash (Seed C) from the coordinator blockchain;
b) generating hash H₂ computed as H₂=hash (R_{B}+Seed B +H_{C}) wherein Seed B is a random number seed generated at the second participant blockchain and R_{B} is a result of the second contract executed on the second participant blockchain;
c) checking H₂ with Seed C; and upon successful checking, releasing Seed B.
